(19) United States
(12) Patent Application Publication
(10) Pub. No.: US 2021/0031297 A1
(43) Pub. Date: Feb. 4, 2021

(54) SYSTEM AND METHOD FOR MULTI-TASK LASER WELDING

(71) Applicant: GM GLOBAL TECHNOLOGY OPERATIONS LLC, Detroit, MI (US)

(72) Inventors: Hongliang Wang, Sterling Heights, MI (US); John S. Agapiou, Rochester Hills, MI (US); John D. Campbell, Rochester Hills, MI (US); Hui-Ping Wang, Troy, MI (US)

(73) Assignee: GM GLOBAL TECHNOLOGY OPERATIONS LLC, Detroit, MI (US)

(21) Appl. No.: 16/529,313

(22) Filed: Aug. 1, 2019

(51) Int. Cl. B23K 26/03; B23K 26/21; B23K 26/70; B23K 31/02; B29C 65/16; B23K 31/12

(52) U.S. Cl. CPC B23K 26/03; B23K 26/21; B23K 31/125; B23K 31/02; B29C 65/16; B23K 26/70

(57) ABSTRACT

A system and method for inspecting and laser welding a workpiece at an area of interest on the workpiece includes a first camera configured to view the area of interest along a first line of sight, a second camera configured to view the area of interest along a second line of sight different from the first line of sight, a laser welding scan head configured to laser weld the workpiece at the area of interest, and a control system configured to receive input from each of the first and second cameras, determine one or more alignment measurements based on the received input, and select a weld schedule from a plurality of weld schedules based on the one or more alignment measurements.

### INTRODUCTION

This disclosure relates to systems and methods for inspecting the alignment of two or more workpieces to be laser welded together and selecting a weld schedule based on the alignment.

In the manufacturing of electric motors, the windings of a stator assembly may be created by inserting copper hairpins into a stator body and joining the tips of the hairpins together. A common approach to joining the hairpins is to utilize arc welding. However, hairpin misalignments may cause defective arc weld joints (such as short circuits and open circuits) if not detected. In common practice, arc welded stator assemblies are inspected and/or electrically tested to look for defective weld joints, and if any are found, they are typically manually rewelded by a human operator. This can be a time-consuming and tedious task, and in common practice the inspection and rewelding operations each occur in separate locations or workstations from the original welding location or workstation, thus requiring additional space and adding transfer time to the process.

### SUMMARY

According to one embodiment, a method includes inspecting an area of interest on a workpiece, determining at least one alignment measurement relating to at least two structures within the area of interest, and selecting, from a plurality of predetermined weld schedules, a weld schedule for laser welding together the at least two structures based on the at least one alignment measurement. The plurality of predetermined weld schedules may include: (i) a first weld schedule in which a laser beam is directed onto the at least two structures so as to weld together the at least two structures; and (ii) a second weld schedule in which the laser beam is first directed at a subset of the at least two structures so as to melt a portion of the subset, and then the laser beam is directed onto the at least two structures so as to weld together the at least two structures.

The method may further include laser welding the at least two structures according to the selected weld schedule to form a weld, and evaluating the weld to produce evaluation data and determining whether the weld passes predetermined weld quality criteria. If the weld passes the weld quality criteria, the method may then include proceeding to a next area of interest; else, the method may include assessing the evaluation data and choosing, from a plurality of predetermined reweld schedules, a reweld schedule for repairing the weld based on the evaluation data. The method may further include rewelding the weld according to the chosen reweld schedule to form a reweld, and checking the reweld to determine whether the reweld passes predetermined reweld quality criteria. If the reweld passes the reweld quality criteria, the method may include proceeding to the next area of interest; else, the method may include identifying the workpiece as needing further intervention, and advancing to an area of interest on a next workpiece. The next area of interest may be located on one of the workpiece and a next workpiece.

The workpiece may be a stator assembly and the area of interest may include at least two hairpin tips. Each of the at least one alignment measurement may be at least one of: (i) a set of spatial coordinates of at least one respective feature of at least one of the at least two structures, the at least one feature being at least one of a respective edge, a respective corner and a respective center of each respective one of the at least one of the at least two structures; and (ii) at least one difference between the respective spatial coordinates of the at least one respective feature for at least two of the at least two structures. The inspecting, laser welding, evaluating and rewelding steps may be performed at a single workstation.

According to one embodiment, a method includes: (a) inspecting an area of interest on a stator assembly; (b) determining at least one alignment measurement relating to at least two hairpin tips within the area of interest; and (c) selecting, from a plurality of predetermined weld schedules, a weld schedule for laser welding together the at least two hairpin tips based on the at least one alignment measurement. The method may further include: (d) laser welding together the at least two hairpin tips according to the selected weld schedule to form a weld; (e) evaluating the weld to produce evaluation data and determining whether the weld passes predetermined weld quality criteria; (f) if the weld passes the weld quality criteria, then proceeding to a next area of interest, else assessing the evaluation data and choosing, from a plurality of predetermined reweld schedules, a reweld schedule for repairing the weld based on the evaluation data; (g) rewelding the weld according to the chosen reweld schedule to form a reweld; (h) checking the reweld to determine whether the reweld passes predetermined reweld quality criteria; (i) if the reweld passes the reweld quality criteria, then proceeding to the next area of interest, else identifying the stator assembly as needing further intervention and advancing to an area of interest on a next stator assembly.

Each of the at least one alignment measurement may be at least one of: a set of spatial coordinates of at least one respective feature of at least one of the at least two hairpin tips, the at least one feature being at least one of a respective edge, a respective corner and a respective center of each respective one of the at least one of the at least two hairpin tips; and at least one difference between the respective spatial coordinates of the at least one respective feature for at least two of the at least two hairpin tips. The inspecting, laser welding, evaluating and rewelding steps may be performed at a single workstation.

According to one embodiment, a system for inspecting and laser welding a workpiece having at least two structures at an area of interest on the workpiece includes: a first camera configured to view the area of interest along a first line of sight; a second camera configured to view the area of interest along a second line of sight different from the first line of sight; a laser welding scan head configured to laser weld the workpiece at the area of interest; and a control system configured to receive input from each of the first and second cameras, determine at least one alignment measurement relating to the at least two structures based on the received input, and select a weld schedule from a plurality of predetermined weld schedules based on the at least one alignment measurement. The plurality of predetermined weld schedules may include: a first weld schedule in which a laser beam is directed onto the at least two structures so as to weld together the at least two structures; and a second weld schedule in which the laser beam is first directed at a subset of the at least two structures so as to melt a portion of the subset, and then the laser beam is directed onto the at least two structures so as to weld together the at least two structures.

The system may be configured in one of: a first configuration, wherein the scan head includes the first camera and the second camera is separate from the scan head; and a second configuration, wherein the first and second cameras are separate from the scan head. The workpiece may be a stator assembly and the area of interest may include two or more hairpin tips. The system may be configured to inspect the area of interest, select the weld schedule, laser weld the workpiece according to the selected weld schedule, and reinspect the area of interest, at a single workstation. The system may further include at least one of: a robotic system connected to and configured for movement of at least one of the laser welding scan head, the first camera and the second camera; and a conveyor system configured for movement of the workpiece; wherein the control system is configured to control the movement of the at least one of the robotic system and the conveyor system.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a top perspective view of a collection of stator hairpins in accordance with the disclosure.

FIG. 2 is a schematic view of an inspection and welding system in accordance with the disclosure.

FIGS. 3A, 3B and 3C are schematic perspective, schematic top and magnified schematic top views, respectively, of hairpins in a first arrangement to be welded according to a first weld schedule in accordance with the disclosure.

FIGS. 4A, 4B and 4C are schematic perspective, schematic top and magnified schematic top views, respectively, of hairpins in a second arrangement to be welded according to a second weld schedule in accordance with the disclosure.

FIGS. 5A, 5B and 5C are schematic perspective, schematic top and magnified schematic top views, respectively, of hairpins in a third arrangement to be welded according to a third weld schedule in accordance with the disclosure.

FIGS. 6A, 6B and 6C are schematic perspective, schematic top and magnified schematic top views, respectively, of hairpins in a fourth arrangement to be welded according to a fourth weld schedule in accordance with the disclosure.

FIG. 7 is a schematic top view of alignment measurements of hairpins in accordance with the disclosure.

FIG. 8 is a schematic side view of alignment measurements of hairpins to be welded in accordance with the disclosure.

FIG. 9 is a flowchart for a method in accordance with the disclosure.

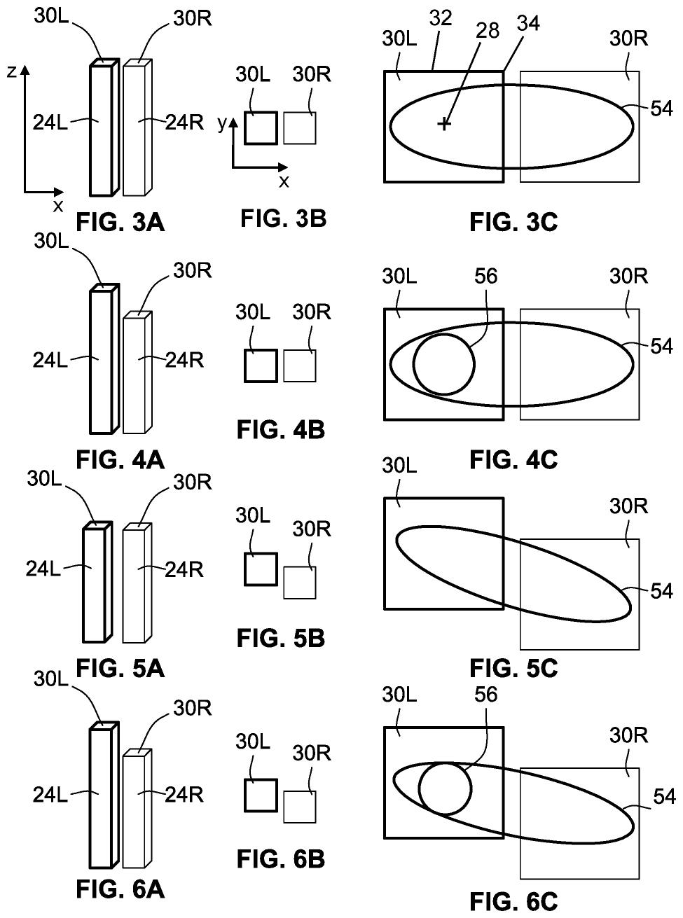

Note that some of the drawings herein are presented in multiple related views, with the related views sharing a common Arabic numeral portion of the figure number and each individual view having its own unique “alphabetic” portion of the figure number. For example, FIGS. 3A, 3B and 3C are schematic perspective, schematic top and magnified schematic top views, respectively, of hairpins to be welded according to an embodiment of the disclosure; all three related views share the same Arabic numeral (i.e., 3), but each individual view has its own unique “alphabetic” designation (i.e., A, B or C). When drawings are numbered in this way, reference may be made herein to the Arabic number alone to refer collectively to all the associated “alphabetics”; thus, “FIG. 3” refers to FIGS. 3A, 3B and 3C collectively. Likewise, “FIG. 4” refers to FIGS. 4A, 4B and 4C collectively.

### DETAILED DESCRIPTION

Referring now to the drawings, wherein like numerals indicate like parts in the several views, a system 40 and method 100 for multi-task inspection and laser welding are shown and described herein. More specifically, the system 40 and method 100 involve inspecting the alignment of two or more structures on a workpiece to be laser welded together (such as the hairpins on a stator assembly), and selecting an appropriate weld schedule based on the alignment of those structures.

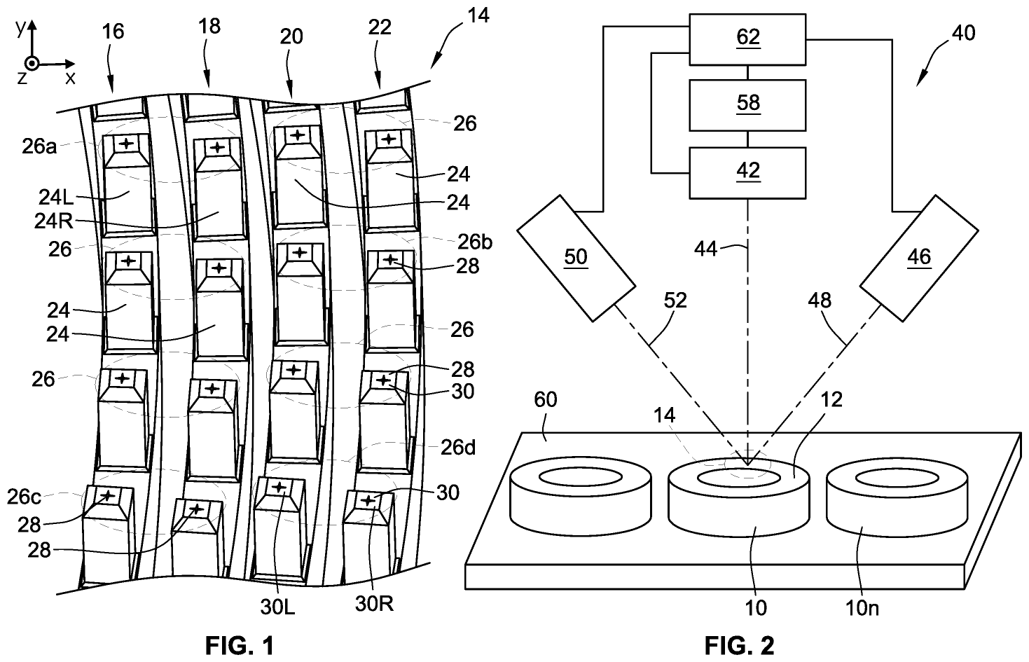

FIGS. 1 and 2 show a stator or stator assembly 10 of an electric motor and a collection of hairpins 24 that are part of the stator 10. The stator 10 is wound having a generally toroidal shape with a generally rectangular cross-section and a generally annular face 12 on each of the two sides of the generally toroidal shape. In FIG. 2, a stator 10 is schematically shown lying down on one side, with the other or top side presenting a generally annular face 12 facing upward. The generally annular face 12 of the stator 10 may present a plurality of hairpins 24 whose tips protrude outward from the generally annular face 12. An area of interest 14 of this generally annular face 12 is indicated by a dashed ellipse in FIG. 2, and a close-up of this area 14 is shown in FIG. 1.

FIG. 1 shows four concentric arc segments 16, 18, 20, 22 of hairpin tips 24. Because FIG. 1 is a close-up or magnified view of the area of interest 14, the arc segments 16, 18, 20, 22 appear as four generally vertical columns, with the hairpins 24 aligned in what appear to be four generally horizontal rows having four hairpin tips 24 in each row. (In actuality, these apparently “vertical” columns and “horizontal” rows are respectively circumferential and radial, and not vertical and horizontal, but they do appear to be arrayed in generally vertical columns and generally horizontal rows when seen in a close-up view.) Each of the hairpins 24 is paired with an adjacent hairpin 24 in the same row to form a grouping or pair 26; thus, there are two groupings or pairs 26 of hairpins 24 in each row of four hairpins 24. These groupings or pairs 26 are indicated by the dashed ellipses 26 shown in FIG. 1. (As used herein, reference numeral 26 is used to indicate both the pairings and the dashed ellipses.) For example, the bottom row of hairpins 24 in FIG. 1 shows two pairs 26: one designated as pair 26c and the other as pair 26d. As will be discussed below, the two hairpins 24 in each pair 26 are to be welded together, such as by laser welding.

Each hairpin tip 24 has an end or face 30 (shown as being generally square or rectangular in shape in FIG. 1), with each face 30 having a center 28 (denoted by a “+” or “plus” mark). Since each pair 26 has two hairpins 24—appearing in FIG. 1 as a first or “left” hairpin 24L and a second or “right” hairpin 24R—then each pair 26 also contains a respective first or “left” hairpin face 30L and a respective second or “right” hairpin face 30R. (Note that the directional descriptions used herein—such as “left”, “right”, “top”, “bottom”, “upward” and the like—are used to describe the apparent orientations as viewed in the drawings. However, these descriptions are used for illustration and convenience of reference only.) The generally horizontal rows of hairpins 24 may define an “x” direction and the generally vertical columns 16, 18, 20, 22 may define a “y” direction generally orthogonal to the “x” direction. (See also the x-y-z coordinate axes at the top-left of FIG. 1. Note that the coordinate axes described herein utilize the conventional “right-hand rule” method of orienting mutually orthogonal x, y and z axes. According to this convention, when the out-of-plane axis has its positive direction coming out of the plane of the drawing, the axis is shown as a dot in a circle (representing the head of an arrow); and when the negative direction of the axis is coming out of the plane of the drawing, it is shown as an “X” in a circle (representing the tail of an arrow).) Using these directions, it appears in FIG. 1 that the centers 28 within certain pairs or ellipses 26 are more “aligned” along the “x” direction (i.e., both of the centers 28 within such pairs or ellipses 26 have about the same “height” in the “y” direction) than is the case with other pairs 26. For example, both centers 28 within ellipse 26a seem to have about the same height in the “y” direction; the same is true for both centers 28 within ellipse 26b. However, the centers 28 within ellipse 26c appear to have significantly different heights in the “y” direction, as do the centers 28 within ellipse 26d. Thus, it may be said that the hairpins 24 in each of ellipses 26a and 26b are more “aligned” along the “x” direction (i.e., the hairpins 24 within each pair 26 have closer heights in the “y” direction) than is the case for the hairpins 24 in ellipses 26c and 26d.

As noted above, the hairpins 24 within each pair 26 are to be joined together. (This is so that an appropriate electrical circuit may be created by the interconnected hairpins 24 within the stator assembly 10.) A common approach to joining the hairpins 24 within each pair 26 is to utilize arc welding. However, hairpin misalignments may cause defective arc weld joints (such as short circuits and open circuits) if not detected. In common practice, arc welded stator assemblies 10 are inspected and/or electrically tested to look for defective weld joints, and if any are found, they are typically manually rewelded by a human operator. This can be a time-consuming and tedious task, and in common practice the inspection and rewelding operations each occur in separate locations or workstations from the original welding location or workstation, thus requiring additional space and adding transfer time to the process.

In contrast, the system 40 and method 100 of the present disclosure involve laser welding to join the hairpins 24 within each pair 26 of a stator assembly 10. Additionally, the system 40 and method 100 involve automated inspection of the hairpin alignment(s) before laser welding (i.e., pre-weld inspection), and selecting an appropriate weld schedule to be used for laser welding each pair 26 based on the alignment(s). After welding, the welds may be inspected (i.e., post-weld inspection) to assess the integrity of the welds, and any needed rewelding can be performed based on the post-weld assessment. In further contrast to other approaches, the system 40 and method 100 of the present disclosure enable the pre-weld inspection, selection of weld schedule, laser welding, post-weld assessment and optional rewelding to be performed at a single workstation.

In addition to the alignments of the hairpins 24 in the “x” and “y” directions discussed above, the alignments of the hairpins 24 in the “z” direction may be attended to as well. This “z” direction represents the distance out from the annular face 12 to which each hairpin tip 24 may extend. (Note that reference numeral 24 may be used herein to refer to hairpins and/or hairpin tips, as the case may be.) FIGS. 3-6 show various perspective and top plan schematic views of four different arrangements of hairpins/hairpin tips 24. In these figures, the “A” drawings show schematic perspective views of two hairpins 24L, 24R, the “B” drawings show schematic top views of the hairpins 24L, 24R, and the “C” drawings show magnified schematic top views of the hairpins 24L, 24R. (The “C” drawings also illustrate various weld schedules, as discussed below.) FIGS. 3-6 illustrate first through fourth arrangements of the hairpins 24L, 24R, respectively. FIG. 3 illustrates a first arrangement in which the two hairpins 24L, 24R are well aligned overall, thus representing an ideal or desired arrangement. In this arrangement, the hairpins 24L, 24R are at about the same height in the “z” direction (as indicated by FIG. 3A) and are also at about the same height in the “y” direction (as indicated by FIG. 3B). FIG. 4 illustrates a second arrangement in which the two hairpins 24L, 24R are at different heights—specifically, the left hairpin 24L is taller than the right hairpin 24R (see FIG. 4A)—yet the hairpins 24L, 24R are at about the same height in the “y” direction (see FIG. 4B). FIG. 5 illustrates a third arrangement in which the hairpins 24L, 24R are at about the same height in the “z” direction (see FIG. 5A), but they are at different heights in the “y” direction (see FIG. 5B). And FIG. 6 illustrates a fourth arrangement in which the hairpins 24L, 24R are at different heights in both the “z” and “y” directions (see FIGS. 6A and 6B, respectively).

Note that in each pair 26 of hairpins 24L, 24R shown in FIGS. 3-6 (as well as in FIGS. 1,7 and 8), each of the two hairpins 24 are at different “x” locations. Because of the way the hairpins 24 are arrayed and grouped in the stator assembly 10 illustrated herein, the “x” locations of the individual hairpins 24L, 24R (and the spacing Δx between their locations) is of less concern than their “y” and “z” locations (and their respective spacings Δy and Δz). This may or may not be the case for other stator assembly configurations and arrangements; therefore, the configurations, arrangements and descriptions of the present disclosure are to be understood as exemplary and not excluding other possible configurations and arrangements.

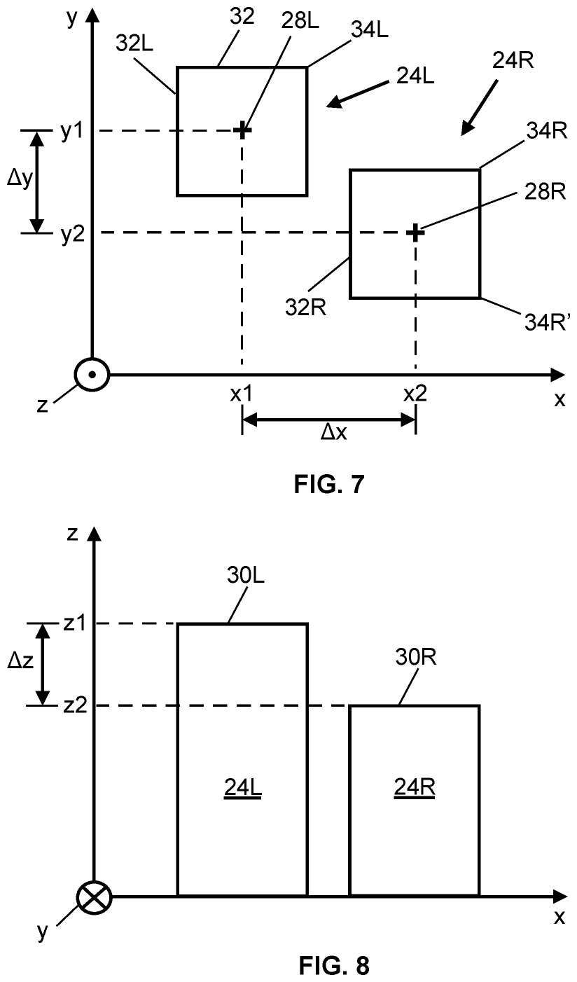

FIGS. 7 and 8 show schematic top and side views of two hairpins 24L, 24R (arranged similar to the fourth arrangement shown in FIGS. 6A and B) illustrating various alignment measurements or data. As discussed further below, these alignment measurements may be determined during pre-weld inspection, as well as during post-weld inspection and post-reweld inspection. The alignment measurements or data may take on one or more of at least two different forms, the first being a set of spatial (e.g., x, y and z) coordinates of one or more features of the hairpins 24L, 24R, and the second being one or more differences (e.g., Δx, Δy and Δz) between the respective spatial coordinates of those features. (Note that as used herein and in the drawings, the directions and coordinate axes may be presented with quotation marks as “x”, “y” and “z”, or without quotation marks as x, y and z.) The aforementioned features may relate to geometric aspects of the hairpin tips 24, such as the edges 32, corners 34 or centers 28. (Note that if the hairpin 24 has a generally circular cross-section, the edge 32 would be the circumference or perimeter of the cross-section.) For example, each of the hairpins 24L, 24R in FIG. 7 has four edges 32, four corners 34 and one center 28. The detection of these features and the determination of the corresponding alignment measurements or data may be carried out using cameras or robotic vision systems along with algorithms for edge detection, center detection, corner detection, etc.

In the first form of alignment measurements or data mentioned above, a feature may have a set of spatial coordinates or measurements, such as measured with respect to a coordinate system or reference frame like the x-y-z coordinate systems in FIGS. 7 and 8. For example, as shown in FIG. 7, the center 28L of the left hairpin 24L has two-dimensional (2D) spatial coordinates (x1, y1), and the center 28R of the right hairpin 24R has 2D coordinates (x2, y2). As shown in FIG. 8, the left center 28L also has a one-dimensional (1D) “z” spatial coordinate (z1), and the right center 28R has a 1D “z” spatial coordinate (z2). These coordinates may be combined into three-dimensional (3D) spatial coordinates, such that the left center 28L has 3D coordinates (x1, y1, z1) and the right center 28R has 3D coordinates (x2, y2, z2). The set of spatial coordinates for each feature may include at least two coordinates, such as (x, y) coordinates, (x, z) coordinates or (y, z) coordinates, depending on the orientation of the workpiece 10 and/or the orientation of the x-y-z coordinate system. The set of spatial coordinates for each feature may also include three coordinates, such as (x, y, z), or may include more than three coordinates. Note that while FIGS. 7 and 8 show planar x-y and x-z views, respectively, a view may show a mixture of x, y and z dimensions, such as the perspective view illustrated in FIG. 1.

In the second form of alignment measurements or data, a feature may be expressed as one or more differences, offsets or distances relative to another feature. Using the previous example again, the centers 28L, 28R have a set of differences (i.e., offsets or distances) between their respective spatial coordinates, where Δx=(x1−x2), Δy=(y1−y2), and Δz=(z1−z2). (These differences may also be expressed as absolute values.) Thus, an alignment measurement for either of these centers 28L, 28R may be expressed as an offset of (Δx, Δy, Δz) from the other center 28L, 28R. Also, a combination of the first and second forms of alignment measurements may be used. For example, an alignment measurement for the left center 28L may be expressed in terms of the first form, such as (x1, y1, z1), while an alignment measurement for the right center 28R may be expressed in terms of the second form, such as (Δx, Δy, Δz). Similar measurements may be determined between or among other features as well, such as the edges 32L, 32R, the corners 34L, 34R, 34R′, and so forth. Also, instead of using a conventional x-y-z orthogonal coordinate system, other coordinate systems may also be used, such as polar, cylindrical, etc. Regardless of the type of coordinate or reference system used, each of the at least one alignment measurement for the two or more selected hairpins 24 may be at least one of: (i) a set of spatial coordinates (e.g., (x, y, z)) of at least one respective feature of at least one of the hairpins 24, and (ii) at least one difference or offset (e.g., (Δx, Δy, Δz)) between the respective spatial coordinates of the at least one respective feature for at least two of the hairpins 24.

FIG. 2 shows a schematic view of a system 40 for inspecting and laser welding a workpiece 10 in accordance with the present disclosure. The workpiece 10 has two or more structures 24 at an area of interest 14 on the workpiece 10; for example, the workpiece 10 may be a stator assembly and the structures 24 may be hairpin tips to be welded together. The system 40 includes a first camera 46 configured to view the area of interest 14 along a first line of sight 48; a second camera 50 configured to view the area of interest 14 along a second line of sight 52 that is different from the first line of sight 48; a laser welding scan head 42 configured to laser weld the workpiece 10 at the area of interest 14; and a control system 62 configured to receive input from each of the first and second cameras 46, 50, determine at least one alignment measurement relating to the two or more structures 24 based on the received input, and select a weld schedule from a plurality of predetermined weld schedules based on the alignment measurement(s).

The control system 62 may be centralized in one part of the system 40, or it may be distributed among two or more parts of the system 40, and it may take the form of hardware, software, algorithms, controllers, sensors, effectors and the like. The input received from each camera 46, 50 may be video images, still images and/or data such as information derived from the video/still images. Such derived data may include the locations or coordinates of one or more features within the images. The control system 62 uses the input from the cameras 46, 50 to determine the alignment measurement(s) relating to the two or more structures 24, either by using a process of calculations and algorithms, or by accepting the alignment measurement(s) from the cameras 46, 50 if the alignment measurement(s) have already been determined by the cameras 46, 50 (such as by image processors on-board each camera 46, 50). For example, the cameras 46, 50 may be used for image acquisition, and the calculations and algorithms for determining the alignment measurements (such as image processing for edge detection) may be performed by one or both cameras 46, 50 and/or by the control system 62.

The system may be configured in one of two ways. In a first configuration, the scan head 42 includes the first camera 46 (i.e., the scan head 42 and first camera 46 are integrated together), and the second camera 50 is separate from (i.e., not integrated with) the scan head 42. And in a second configuration (which is shown in FIG. 2), the first and second cameras 46, 50 are separate from (i.e., not integrated with) the scan head 42. In either configuration, the cameras 46, 50 are separated from each other and are positioned in a way that enables viewing of the x, y and z dimensions of the area of interest 14, so that the alignment measurements of the structures or hairpins 24 may be determined. For example, in the first configuration, the integrated scan head/first camera 42, 46 may be disposed directly over the area of interest 14 so that the x and y dimensions and alignment measurements may be determined, while the second camera 50 may be offset (i.e., its line of sight 52 not parallel or coincident with the laser beam 44 or the other camera's line of sight 48) so that the z dimension and alignment measurements may be determined. In either configuration, the first and second cameras 46, 50 may cooperate to provide a 3D view of the area of interest 14, and the system 40 may be configured to inspect the area of interest 14, select the weld schedule, laser weld the workpiece 10 according to the selected weld schedule, and reinspect the area of interest 14, all at a single workstation.

The system 40 may further include a robotic system 58 connected to and configured for movement of at least one of the laser welding scan head 42, the first camera 46 and the second camera 50. Additionally (or alternatively), the system 40 may include a conveyor system 60 configured for movement of the workpiece 10. The control system 62 may be configured to control the movement of the robotic system 58 and/or the conveyor system 60. For example, the robotic system 58 may include an end effector which moves the scan head 42, the first camera 46 and/or the second camera 50 so that the laser beam 44 and the lines of sight 48, 52 are focused upon the area of interest 14. (Note that the area of interest 14 may include one set of structures 24 to be inspected and laser welded, or two or more sets of structures 24, and optionally may include some surrounding area outside of the one or more set(s) of structures 24.) The robotic end effector 58 may move the scan head/cameras 42, 46, 50 as needed from one area of interest 14 on the workpiece 10 to another area of interest on the workpiece 10, as well as to an area of interest 14 on the next workpiece 10n to be inspected and welded. Along with (or instead of) this movement by the robotic system 58, the conveyor system 60 may provide a work area (e.g., a flat table-like area) which is configured to move the workpiece(s) 10, 10n as needed to position the area of interest 14 at the focal point of the laser beam 44 and the cameras' lines of sight 48, 52. Thus, when one or more sets of structures 24 have been welded and the post-weld inspection (and any rewelding) have been completed, the conveyor system 60 and/or the robotic system 58 may position the scan head/cameras 42, 46, 50 and/or the workpiece(s) 10, 10n so that the focal point and the next area of interest 14 (e.g., the next set of structures 24) may coincide, so that the inspection and laser welding of the next set of structures 24 may commence.

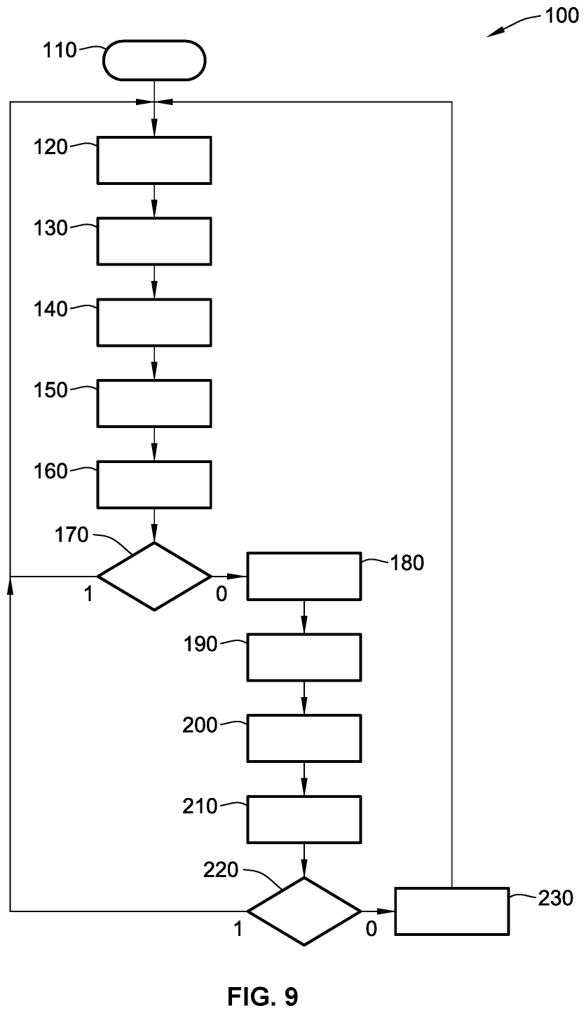

FIG. 9 shows a flowchart of a method 100 in accordance with the present disclosure. The method 100 starts at block 110 and may be implemented using a system 40 as described herein. At block 120, the system 40 is focused on an area of interest 14. This area 14 may be a portion of a stator or other workpiece 10 having hairpins or other structures 24 to be laser welded together. At block 130, the area of interest 14 is inspected, such as by the first and second cameras 46, 50, and at least one alignment measurement is determined relating to two or more hairpin tips or other structures 24 within the area of interest 14. At block 140, a weld schedule is selected from a plurality of predetermined weld schedules, for laser welding together the two or more hairpin tips or structures 24 based on the at least one alignment measurement. At block 150, the two or more hairpin tips or structures 24 are laser welded together according to the selected weld schedule to form a weld. At block 160, the weld is evaluated to produce evaluation data, and at decision block 170 it is determined whether the weld passes predetermined weld quality criteria. The evaluation data may include data relating to the size, shape, color, composition and location of the weld compared to the size, shape and location of each of the two hairpin tips or structures 24, and this evaluation data may be compared to the predetermined weld quality criteria, which may include go/no-go parameters for whether a given weld is acceptable or not.

If the weld passes the weld quality criteria (represented by the branch denoted as “1” at decision block 170), then the method 100 (and system 40) may proceed to block 120 and to a next area of interest 14 (which may be on the same stator or workpiece 10, or, if all areas of interest 14 for the stator or workpiece 10 have been inspected and laser welded, then a next stator or workpiece 10n may be proceeded to). Otherwise, if the weld does not pass the weld quality criteria (represented by the branch denoted as “0” at decision block 170), then at block 180 the evaluation data (produced at block 160) is assessed. At block 190, a reweld schedule for repairing the weld based on the evaluation data is chosen from a plurality of predetermined reweld schedules. At block 200, the weld is rewelded (i.e., laser welded again) according to the chosen reweld schedule to form a reweld. At block 210, the reweld is checked to determine whether the reweld passes predetermined reweld quality criteria. At decision block 220, it is determined whether the reweld passes the reweld quality criteria. If the reweld passes the reweld quality criteria (represented by the branch denoted as “1” at decision block 220), then the method 100 (and system 40) may proceed to block 120 and to a next area of interest 14. Otherwise, if the reweld does not pass the reweld quality criteria (represented by the branch denoted as “0” at decision block 220), then at block 230 the stator assembly or workpiece 10 is identified as needing further intervention. This identification may take various forms, such as ejecting the stator or workpiece 10 from the immediate work area, setting a register, storing a value, sounding an alarm, triggering a flashing or special light, or otherwise identifying the defective workpiece 10 and/or indicating that human or other attention or intervention is needed. After block 230, the method 100 (and system 40) may advance to an area of interest 14 on a next stator assembly or workpiece 10n. The inspecting, laser welding, evaluating and rewelding steps may be performed at a single location or workstation, thus avoiding the complexity, tedium, transfer time and other drawbacks of competing approaches.

The predetermined weld schedules, predetermined weld quality criteria and predetermined reweld quality criteria may be stored as part of the control system 62, and/or the control system 62 may access some or all of the foregoing from outside the control system 62 as needed (such as from a server, a network, the cloud, another component of the system 40, etc.) The plurality of predetermined weld schedules may include at least two weld schedules. In a first weld schedule, a laser beam 44 is directed onto the two or more hairpins or structures 24 (e.g., generally simultaneously) so as to weld them together. In a second weld schedule, the laser beam 44 is first directed at a subset of the two or more hairpins or structures 24 so as to melt a portion of the subset, and then the laser beam is directed onto the two or more hairpins or structures 24 so as to weld them together. For example, when two hairpins 24 of different heights are to be laser welded together, the “subset” of the two hairpins 24 may be the one hairpin 24 that is taller than the other, and the “portion of the subset” may be some portion of the tip or face 30 of the taller hairpin 24. The second weld schedule may direct the laser beam 44 at the taller of the two hairpins 24 to melt its tip so that its height is decreased, with the aim of making its resulting height about the same as the height of the other hairpin 24. The alignment measurement(s) may be utilized to determine how much taller the taller hairpin 24 is (e.g., Δz), and this information (optionally along with other alignment measurements, e.g., Δx and/or Δy) may be used to determine the energy, coverage and duration for focusing the laser beam 44 onto the taller hairpin 24 in order to decrease the height of the taller hairpin 24 to a desired reduced height (e.g., the same height as the other hairpin 24 in the pair 26).

The alignment measurements or data may be used to determine which weld schedule is appropriate for each pair 26 of hairpins 24, or for each set of two or more structures 24 to be welded together, as the case may be. FIGS. 3C and 5C illustrate two different versions of the first weld schedule. In both cases, the hairpins or structures 24 are about the same “z” height; however, while they have about the same “y” height in FIG. 3C, they have different “y” heights in FIG. 5C. In both cases, the (x, y, z) or (Δx, Δy, Δz) data for these two hairpins or structures 24 may be utilized to determine the size, shape and angular orientation of the laser beam 44 or beam footprint 54 that is needed to bridge both hairpins or structures 24. FIGS. 3C and 5C show an elliptical beam shape; in FIG. 3C the long axis of the ellipse 54 appears generally aligned with the “x” axis (i.e., generally zero degrees of angular tilt with respect to the “x” axis), while in FIG. 5C the ellipse 54 appears to be angularly tilted with respect to the “x” axis so that the beam 54 covers the two hairpins or structures 24 that are offset from each other in the “y” direction. Similarly, FIGS. 4C and 6C illustrate two different versions of the second weld schedule; in both cases, the two hairpins or structures 24 have different “z” heights, and the shape of the beam 54 that bridges both hairpins or structures 24 may be angularly or otherwise adjusted to accommodate the difference in “y” heights. (Recall that as described above, for cases of hairpins or structures 24 having different heights in the “z” direction, the second weld schedule includes first directing the laser beam 44 at the taller of the two hairpins or structures 24, thus producing a beam footprint 56 on the taller hairpin or structure 24 that is smaller than the beam footprint 54 that bridges both hairpins or structures 24.) Note that while FIGS. 4-6 illustrate four different configurations and weld schedules, other weld schedules or strategies may be used in addition to or instead of these four weld schedules.

Note that in the present disclosure, reference numeral 24 is used to refer to hairpins, hairpin tips and structures within an area of focus 14. Also, reference numeral 10 is used to refer to workpieces and stator assemblies, and 10n is used to refer to next workpieces and next stator assemblies. Thus, workpieces 10 and structures 24 refer to a more generalized case, while stator assemblies 10 and hairpins/hairpin tips 24 refer to a more specific case. As used herein, these respective generalized and specific terms may be used interchangeably. Likewise, generalized examples and descriptions herein also apply to specific examples and descriptions, and vice versa.

The above description is intended to be illustrative, and not restrictive. While various specific embodiments have been presented, those skilled in the art will recognize that the disclosure can be practiced with various modifications within the spirit and scope of the claims. For example, the above-described embodiments (and/or aspects thereof) may be used in combination with each other. In addition, many modifications may be made to adapt a particular situation or material to the teachings of the disclosure without departing from its scope. While the dimensions and types of materials described herein are intended to be illustrative, they are by no means limiting and are exemplary embodiments. As used herein, an element or step recited in the singular and preceded by the word “a” or “an” should be understood as not excluding plural of such elements or steps, unless such exclusion is explicitly stated. Additionally, the phrase “at least one of A and B” should be understood to mean “only A, only B, or both A and B.” Furthermore, references to a particular embodiment or example are not intended to be interpreted as excluding the existence of additional embodiments or examples that also incorporate the recited features. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “for the most part”, “to a significant extent” and/or “to a large degree”, and do not necessarily mean “perfectly”, “completely”, “strictly” or “entirely”.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method, comprising:
inspecting an area of interest on a workpiece;
determining at least one alignment measurement relating to at least two structures within the area of interest; and
selecting, from a plurality of predetermined weld schedules, a weld schedule for laser welding together the at least two structures based on the at least one alignment measurement.

2. A method according to claim 1, further comprising:
laser welding the at least two structures according to the selected weld schedule to form a weld; and
evaluating the weld to produce evaluation data and determining whether the weld passes predetermined weld quality criteria.

3. A method according to claim 2, further comprising:
if the weld passes the weld quality criteria, then proceeding to a next area of interest; else assessing the evaluation data, and
choosing, from a plurality of predetermined reweld schedules, a reweld schedule for repairing the weld based on the evaluation data.

4. A method according to claim 3, further comprising:
rewelding the weld according to the chosen reweld schedule to form a reweld; and
checking the reweld to determine whether the reweld passes predetermined reweld quality criteria.

5. A method according to claim 4, further comprising:
if the reweld passes the reweld quality criteria, then proceeding to the next area of interest; else
identifying the workpiece as needing further intervention, and
advancing to an area of interest on a next workpiece.

6. A method according to claim 5, wherein the next area of interest is located on one of the workpiece and a next workpiece.

7. A system according to claim 1, wherein the workpiece is a stator assembly and the area of interest includes at least two hairpin tips.

8. A method according to claim 1, wherein each of the at least one alignment measurement is at least one of:
a set of spatial coordinates of at least one respective feature of at least one of the at least two structures, the at least one feature being at least one of a respective edge, a respective corner and a respective center of each respective one of the at least one of the at least two structures; and
at least one difference between the respective spatial coordinates of the at least one respective feature for at least two of the at least two structures.

9. A method according to claim 4, wherein the inspecting, laser welding, evaluating and rewelding steps are performed at a single workstation.

10. A method according to claim 2, wherein the plurality of predetermined weld schedules includes:
a first weld schedule in which a laser beam is directed onto the at least two structures so as to weld together the at least two structures; and
a second weld schedule in which the laser beam is first directed at a subset of the at least two structures so as to melt a portion of the subset, and then the laser beam is directed onto the at least two structures so as to weld together the at least two structures.

11. A method, comprising:
inspecting an area of interest on a stator assembly;
determining at least one alignment measurement relating to at least two hairpin tips within the area of interest; and
selecting, from a plurality of predetermined weld schedules, a weld schedule for laser welding together the at least two hairpin tips based on the at least one alignment measurement.

12. A method according to claim 11, further comprising:
laser welding together the at least two hairpin tips according to the selected weld schedule to form a weld;
evaluating the weld to produce evaluation data and determining whether the weld passes predetermined weld quality criteria;
if the weld passes the weld quality criteria, then proceeding to a next area of interest, else assessing the evaluation data, and
choosing, from a plurality of predetermined reweld schedules, a reweld schedule for repairing the weld based on the evaluation data;
rewelding the weld according to the chosen reweld schedule to form a reweld;
checking the reweld to determine whether the reweld passes predetermined reweld quality criteria;
if the reweld passes the reweld quality criteria, then proceeding to the next area of interest, else
identifying the stator assembly as needing further intervention, and
advancing to an area of interest on a next stator assembly.

13. A method according to claim 11, wherein each of the at least one alignment measurement is at least one of:
a set of spatial coordinates of at least one respective feature of at least one of the at least two hairpin tips, the at least one feature being at least one of a respective edge, a respective corner and a respective center of each respective one of the at least one of the at least two hairpin tips; and
at least one difference between the respective spatial coordinates of the at least one respective feature for at least two of the at least two hairpin tips.

14. A method according to claim 11, wherein the inspecting, laser welding, evaluating and rewelding steps are performed at a single workstation.

15. A system for inspecting and laser welding a workpiece having at least two structures at an area of interest on the workpiece, comprising:
a first camera configured to view the area of interest along a first line of sight;
a second camera configured to view the area of interest along a second line of sight different from the first line of sight;
a laser welding scan head configured to laser weld the workpiece at the area of interest; and
a control system configured to receive input from each of the first and second cameras, determine at least one alignment measurement relating to the at least two structures based on the received input, and select a weld schedule from a plurality of predetermined weld schedules based on the at least one alignment measurement.

16. A method according to claim 15, wherein the plurality of predetermined weld schedules includes:
a first weld schedule in which a laser beam is directed onto the at least two structures so as to weld together the at least two structures; and
a second weld schedule in which the laser beam is first directed at a subset of the at least two structures so as to melt a portion of the subset, and then the laser beam is directed onto the at least two structures so as to weld together the at least two structures.

17. A system according to claim 15, wherein the system is configured in one of:
a first configuration, wherein the scan head includes the first camera and the second camera is separate from the scan head; and
a second configuration, wherein the first and second cameras are separate from the scan head.

18. A system according to claim 15, wherein the workpiece is a stator assembly and the area of interest includes two or more hairpin tips.

19. A system according to claim 15, wherein the system is configured to inspect the area of interest, select the weld schedule, laser weld the workpiece according to the selected weld schedule, and reinspect the area of interest, at a single workstation.

20. A system according to claim 15, further comprising at least one of:
a robotic system connected to and configured for movement of at least one of the laser welding scan head, the first camera and the second camera; and
a conveyor system configured for movement of the workpiece;
wherein the control system is configured to control the movement of the at least one of the robotic system and the conveyor system.
